(19) United States
(12) Patent Application Publication
(10) Pub. No.: US 2023/0153638 A1
(43) Pub. Date: May 18, 2023

(54) COLUMN-DISTRIBUTED TREE-BASED DATA MINING ENGINES FOR BIG DATA IN CLOUD SYSTEMS

(71) Applicant: SAP SE, Walldorf (DE)

(72) Inventors: Zhen Zhang, Shanghai (CN); Hao Wang, Shenzhen (CN); Xing Zhao, Shanghai (CN)

(21) Appl. No.: 17/455,241

(22) Filed: Nov. 17, 2021

(51) Int. Cl. G06N 5/02; G06F 16/22; G06N 5/00

(52) U.S. Cl. CPC G06N 5/022; G06F 16/221; G06N 5/003

(57) ABSTRACT

Methods, systems, and computer-readable storage media for training of machine learning (ML) models and inference using the ML models based on distributed data mining in cloud systems, and more particularly for a distributed, tree-based data mining system that uses column-distributed tree-based data mining in a cloud system to support training of and inference using ML models.

### BACKGROUND

Cloud computing systems (cloud systems) are often used for processing of large data sets. For example, cloud systems can receive data from various data sources and process the data to perform certain functionality. In an example context, data sources can include various types of so-called Internet-of-Things (IoT) devices (e.g., sensors, mobile phones, smart traffic lights, remote surveillance cameras) that are located at the edges of networks. IoT devices collectively generate massive amounts of data that is processed to perform certain functionality. For example, data can be provided as input to one or more machine learning (ML) models, which generate predictions, also referred to as inferences, that can be used in downstream operations and/or decision-making processes.

As a result of large volumes of datasets spread across cloud systems, large-scale data mining algorithms have been developed. However, difficulties arise in achieving time- and resource-efficient distributed data mining. Further, such voluminous datasets are often accumulated on column-distributed storage platforms. In the context of ML, such distributed data is difficult to manage for training ML models and/or conducting inference using ML models. In view of this, distributed learning methods and inference methods need to be developed to enable column-distributed data to be appropriately processed, particularly in the ML context.

### SUMMARY

Implementations of the present disclosure are directed to training of machine learning (ML) models and inference using the ML models based on distributed data mining in cloud systems. More particularly, implementations of the present disclosure are directed to a distributed, tree-based data mining system that uses column-distributed tree-based data mining in a cloud system to support training of and inference using ML models.

In some implementations, actions include transmitting, from a resource manager node, a set of training tasks to a set of worker nodes, the set of workers nodes including two or more worker nodes distributed across the cloud system and each having access to a respective local data store, the set of training tasks being executed to provide a ML model, by each worker node in the set of worker nodes, executing a respective training task to provide a set of local parameters and transmitting the set of local parameters to the resource manager node, merging, by the resource manager node, two or more sets of local parameters to provide a set of global parameters, transmitting, by the resource manager node, a sub-set of global parameters to each parameter server in a set of parameter servers, receiving, by the resource manager node, a set of local optimal splits, each local optimal split in the set of local optimal splits being transmitted to the resource manager node from a respective parameter server, determining an optimal global split based on the set of local optimal splits, the optimal global split representing a feature of the ML model, and updating, by the resource manager node, the ML model based on the optimal global split. Other implementations of this aspect include corresponding systems, apparatus, and computer programs, configured to perform the actions of the methods, encoded on computer storage devices.

These and other implementations can each optionally include one or more of the following features: each training task includes a set of identifiers, each identifier indicating data that is to be used to execute the training task; the two or more sets of local parameters is determined based on a control parameter that limits the two or more sets of local parameters to less than all sets of local parameters received from the set of worker nodes; actions further include, during inference, receiving, by a worker node, the ML model from the resource manager node, determining, by the worker node, a binary code based on the ML model and data stored in a local data store accessible by the worker node, transmitting, by the worker node, the binary code to the resource manager node, providing, by the resource manager node, a set of binary codes to a parameter server, the set of binary codes including the binary code, the parameter server executing an operation on the set of binary codes to provide a result to the resource manager, and determining, by the resource manager, an inference result of the ML model at least partially based on the result; the binary code represents a portion of the ML model that the worker node is capable of resolving using at least a portion of the data stored in the local data store accessible by the worker node; each local data store includes a column-oriented data store; the ML model includes a decision tree.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example architecture for a data mining system in accordance with implementations of the present disclosure.

FIG. 3 depicts an example architecture illustrating interactions between components during workflow execution in accordance with implementations of the present disclosure.

FIG. 4 depicts an example decision tree model to illustrate implementations of the present disclosure.

FIG. 5 depicts an example process that can be executed in accordance with implementations of the present disclosure.

FIG. 6 depicts an example process that can be executed in accordance with implementations of the present disclosure.

FIG. 7 is a schematic illustration of example computer systems that can be used to execute implementations of the present disclosure.

Like reference symbols in the various drawings indicate like elements.

### DETAILED DESCRIPTION

Implementations of the present disclosure are directed to training of machine learning (ML) models and inference using the ML models based on distributed data mining in cloud systems. More particularly, implementations of the present disclosure are directed to a distributed, tree-based data mining system that uses column-distributed tree-based data mining in a cloud system to support training of and inference using ML models. Implementations can include actions of transmitting, from a resource manager node, a set of training tasks to a set of worker nodes, the set of workers nodes including two or more worker nodes distributed across the cloud system and each having access to a respective local data store, the set of training tasks being executed to provide a ML model, by each worker node in the set of worker nodes, executing a respective training task to provide a set of local parameters and transmitting the set of local parameters to the resource manager node, merging, by the resource manager node, two or more sets of local parameters to provide a set of global parameters, transmitting, by the resource manager node, a sub-set of global parameters to each parameter server in a set of parameter servers, receiving, by the resource manager node, a set of local optimal splits, each local optimal split in the set of local optimal splits being transmitted to the resource manager node from a respective parameter server, determining an optimal global split based on the set of local optimal splits, the optimal global split representing a feature of the ML model, and updating, by the resource manager node, the ML model based on the optimal global split.

To provide further context for implementations of the present disclosure, and as introduced above, cloud computing systems (cloud systems) are often used for processing of large data sets. For example, cloud systems can receive data from various data sources and process the data to perform certain functionality. In an example context, data sources can include various types of so-called Internet-of-Things (IoT) devices (e.g., sensors, mobile phones, smart traffic lights, remote surveillance cameras) that are located at the edges of networks. IoT devices collectively generate massive amounts of data that is processed to perform certain functionality. For example, data can be provided as input to one or more ML models, which generate predictions, also referred to as inferences, that can be used in downstream operations and/or decision-making processes.

As a result of large volumes of datasets spread across cloud systems, large-scale data mining algorithms have been developed. However, difficulties arise in achieving time- and resource-efficient distributed data mining. Further, such voluminous datasets are often accumulated on column-distributed storage platforms. In the context of ML, such a distributed data is difficult to manage for training ML models and/or conducting inference using ML models. In view of this, distributed learning methods and inference methods need to be developed to enable column-distributed data to be appropriately processed.

With the increase of the number of sensors, storage capacity and bandwidth, large datasets are becoming increasingly common in cloud systems. Distributed data mining algorithms have been designed and employed to deal with those specialized datasets, which have benefited from improvement of hardware architectures and programming frameworks. An example hardware architecture includes SAP Cloud and an example programming framework includes SAP HANA Smart Data Integration, each provided by SAP SE of Walldorf, German.

Tree-based ML models present a particularly difficult challenge in achieving efficiencies. For example, existing parallelization schemes, such as MapReduce, are not suitable due to the excessive communication load and lack support for column-distributed data. In general, column-distributed data refers to features of data records being stored in different databases (nodes) in a distributed system. For example, and without limitation, a dataset can have multiple records (e.g., 2000), each record including multiple features (e.g., temperature, outlook, windy, humidity). As column-distributed data, a sub-set of features (e.g., temperature, windy) of the records (e.g., all 2000) are stored on a first node, and a sub-set of features (e.g., outlook, humidity) of the records (e.g., all 2000) are stored on a second node. In some examples, each feature corresponds to a column of a database table, and columns can be stored across multiple nodes (e.g., columns storing values of temperature and windy stored in the first node, columns storing values of outlook and humidity stored in the second node).

By way of non-limiting example, a mainstream MapReduce distributed computing framework has been implemented for data analysis and data management on cloud computing systems (e.g., Amazon Elastic Computer Cloud (EC2), Google Cloud). Such distributed computing framework has disadvantages. For example, data is gathered at each storage node (e.g., from IoT devices) and is then transmitted to a central data warehouse for processing on interconnected computing clusters. This results in an increase in processing time, intensive network traffic, increased risk of unauthorized access to sensitive data, and high demand on Internet bandwidth. As another example, a conventional data-parallelism strategy is used in distributed processing. However, inputting large datasets means generating complex tree models with an enormous number of parameters. Accessing the parameters in a master node from client nodes requires a large amount of network bandwidth and long wait times for synchronization. As another example, and in the context of ML models providing predictions (inference), traditional distributed learning techniques do not support parallel prediction. That is, traditional distributed learning techniques only work sequentially. However, in many cases that require real-time ML inference (e.g., sensing in the context of self-driving cars), any inference latency may lead to unpredictable losses.

In view of the above context, implementations of the present disclosure provide a distributed, tree-based data mining system that uses column-distributed tree-based data mining in cloud systems. As described in further detail herein, the data mining system of the present disclosure enables data processing to be moved as close as possible to the sources of data. More particularly, all data mining executions involving data take place at distributed processing nodes, to minimize data copying and/or movement. Further, central compute nodes summarize parameters that are received and generate final tree models (ML models). In the prediction phase (inference), implementations of the present disclosure enable a resource-efficient, parallel training of and inference using ML models.

Implementations of the present disclosure are described in further detail herein with non-limiting reference to an example use case. It is contemplated, however, that implementations of the present disclosure can be realized for any appropriate use case. In the example use case, a global supply chain is considered for components of an aircraft manufacturer, which are manufactured worldwide. For example, a factory in a city of a country provides engines, while a factory in another city of another country supplies landing gear. Each factory stores the information only about its produced components within a database system (e.g., SAP HANA), hence, each factory can be considered a storage node that stores data. The aircraft manufacturer, with headquarters and assembly lines located in yet another city of still another country, wants to estimate the output number of the airplanes in each year, while maintaining defined quality standards for all components. Here, the aircraft manufacturer can also be considered a storage node. In this scenario, each storage node records only a subset of the needed information. That is, a storage node is provided at each location and stores data generated at the location. A traditional centralized approach that aggregates data from individual storage nodes (e.g., from the engine manufacturer and the landing gear manufacturer) and builds tree ensemble models will be resource-expensive in terms of communication, data storage, and computation. As described in further detail herein, the data mining system of the present disclosure enables resource-efficient processing of such distributed datasets at individual nodes and all nodes are coordinated to achieve scalability.

IoT devices are referenced herein. In some examples, IoT devices can be described as nonstandard computing devices that are able to transmit data over a network. Example devices can include, without limitation, sensors, smart phones, smart meters, smart traffic lights, engines, motors, compressors, solenoids, and the like. In some examples, one or more IoT devices are components of a larger application including, for example and without limitation, a car, a truck, a train, a plane, a boat, a ship, a building, a factory, and the like. In some examples, the IoT devices are wirelessly connected to the network. For example, and without limitation, an IoT device can include an electric motor having one or more sensors that are responsive to operation of the electric motor to generate signals representative of respective operating parameters of the electric motor.

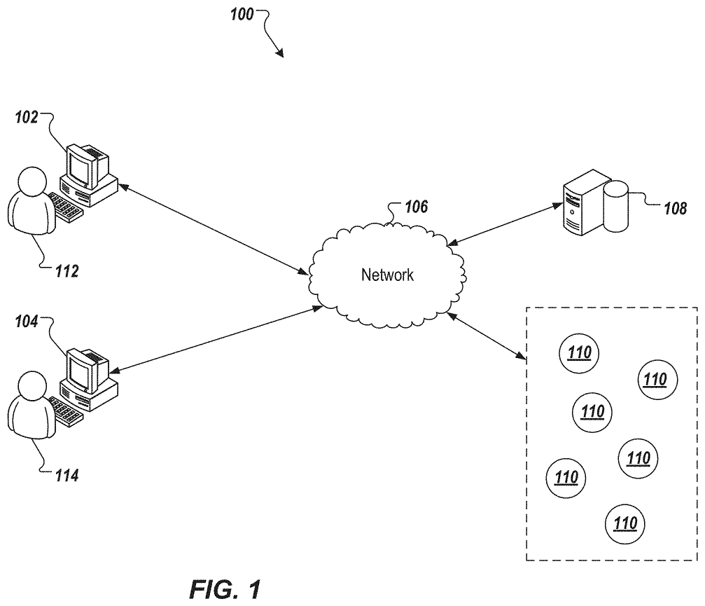

FIG. 1 depicts an example architecture 100 in accordance with implementations of the present disclosure. In the depicted example, the example architecture 100 includes one or more client devices 102, 104, a network 106, a server system 108, and nodes 110. The server system 108 includes one or more server devices and databases (e.g., processors, memory). In the depicted example, respective users 112, 114 interact with the client devices 102, 104. In an example context, the users 112, 114 can include users (e.g., enterprise operators, maintenance agents), who interact with a data mining system hosted by the server system 108.

In some examples, the client devices 102, 104 can communicate with the server system 108 over the network 106. In some examples, the client devices 102, 104 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 108 includes at least one server and at least one data store. In the example of FIG. 1, the server system 108 is intended to represent various forms of servers including, but not limited to a web server, an application server, a proxy server, a network server, and/or a server pool. In general, server systems accept requests for application services and provides such services to any number of client devices (e.g., the client devices 102, 104 over the network 106).

In some implementations, one or more data stores of the server system 108 store one or more databases. In some examples, a database can be provided as an in-memory database. In some examples, an in-memory database is a database management system that uses main memory for data storage. In some examples, main memory includes random access memory (RAM) that communicates with one or more processors (e.g., central processing units (CPUs)), over a memory bus. An-memory database can be contrasted with database management systems that employ a disk storage mechanism. In some examples, in-memory databases are faster than disk storage databases, because internal optimization algorithms can be simpler and execute fewer CPU instructions (e.g., require reduced CPU consumption). In some examples, accessing data in an in-memory database eliminates seek time when querying the data, which provides faster and more predictable performance than disk-storage databases. An example in-memory database system includes SAP HANA provided by SAP SE of Walldorf, Germany.

In some examples, the nodes 110 can represent distributed locations, at which data is stored. The data can be collectively considered distributed data that can be processed to achieve some end. For example, and as described in further detail herein, data from each of the nodes 110 can be processed to collectively provide an inference from a ML model. In some examples, one or more nodes 110 can each include a device (e.g., an IoT device that generates data that is stored at a respective location). In some examples, one or more nodes 110 can each include a data store that provides column-oriented storage of data in a local database system.

Implementations of the present disclosure can be described with reference to an example problem definition, as follows. Assume data is collected and stored in column distribution, which can be expressed as:

X∈R^{f}_{1+f}_{2+. . . +f}ₘ=R^{N}

where fᵢ for i=1, 2, . . . , m corresponds to the number of columns of stored data in the m data centers. A dataset can be represented as:

D={(xᵢ,yᵢ)|xᵢ∈R^{N},yᵢ∈R}

which is sampled from an unknown distribution. The goal is to find a function ƒ_{RN→R} that minimizes a metric used to measure a distance between predicted values and the ground truth values. Tree-based models represent ƒ by recursively partitioning R^{N} into smaller non-overlapping regions and finally leaf nodes that present regional predictions that cannot be further subdivided. As described, the data is partitioned and arranged by features (columns) rather than samples (rows), which presents herein-discussed challenges to tree-based data mining algorithms that rely on the overall data distribution. This is particularly true for the prediction phase (inference), because the decision path can always be conditioned on features that distribute on different storage nodes. Consequently, it is difficult to obtain results only with the information and data on one node.

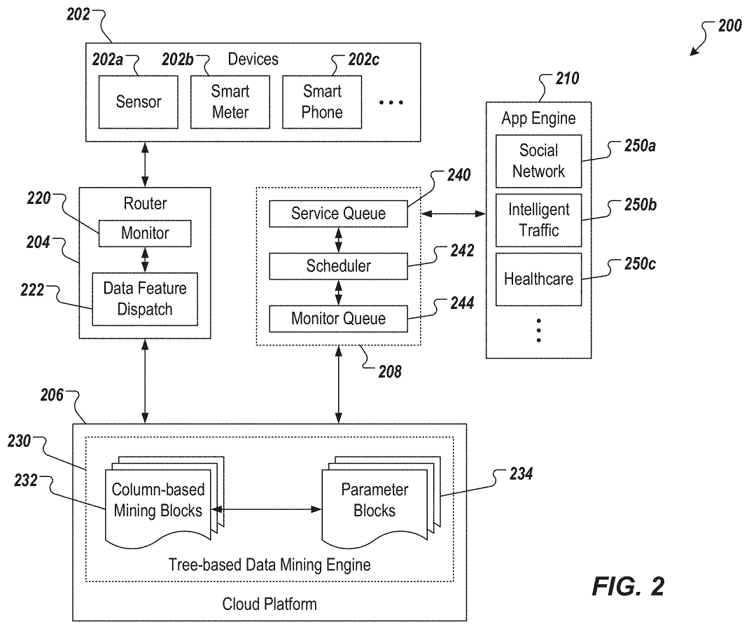

FIG. 2 depicts an example architecture 200 for a data mining system in accordance with implementations of the present disclosure. The example architecture 200 represents a parallel architecture that utilizes distribute stored data and provides improved prediction accuracy and resource-efficiencies in the training phase and the prediction phase as compared to traditional approaches.

In the example of FIG. 2, the example architecture 200 includes a set of devices 202, a router 204, a cloud platform 206, an inference manager 208, and an application engine 210. The set of devices 202 includes devices 202a, 202b, 202c. In some examples, one or more of the devices 202a, 202b, 202c can be an IoT device. In some examples, each device 202a, 202b, 202c represents a location, at which data is generated and stored. For example, and with reference to the example use case, the device 202a can represent a factory (e.g., engine), the device 202b can represent another factory (e.g., landing gear), and the device 202c can represent the airplane manufacturer's headquarters.

The router 204 includes a monitor module 220 and a data feature dispatch module 222. The cloud platform executes a tree-based data mining (TDM) engine 230, which processes column-based mining blocks 232 and parameter blocks 234, as described in further detail herein. The inference manager 208 includes a service queue 240, a scheduler 242, and a monitor queue 244. The application engine 210 executes one or more applications 250a, 250b, 250c.

The example of FIG. 2 represents an example use case, in which the devices 202 collect data that is dispatched by the router 204 for storage in the cloud platform 206. For example, the monitor module 220 can be responsive to data being generated by one or more of the devices 202 and can retrieve the data from respective devices 202. The data feature dispatch module 222 can dispatch the data for storage within the cloud platform 206. For example, values of a first sub-set of features (e.g., temperature, windy) can be sent for storage at a first node within the cloud platform 206, and values of a second sub-set of features (e.g., outlook, humidity) can be sent for storage at a second node within the cloud platform 206. In accordance with implementations of the present disclosure, and as described in further detail herein, one or more tree-based models can be trained using the data, which is stored as column-distributed data.

As also described in further detail herein, a (trained) tree-based ML model can be used to provide inferences. For example, one or more of the applications 250a, 250b, 250c can consume inferences of one or more tree-based ML models through the inference manager 208. In this manner, the applications 250a, 250b, 250c can selectively execute prescribed functionality in response to inferences received from the tree-based ML models. In some examples, an inference request can be provide through the inference manager 208, which returns an inference result to a requesting application.

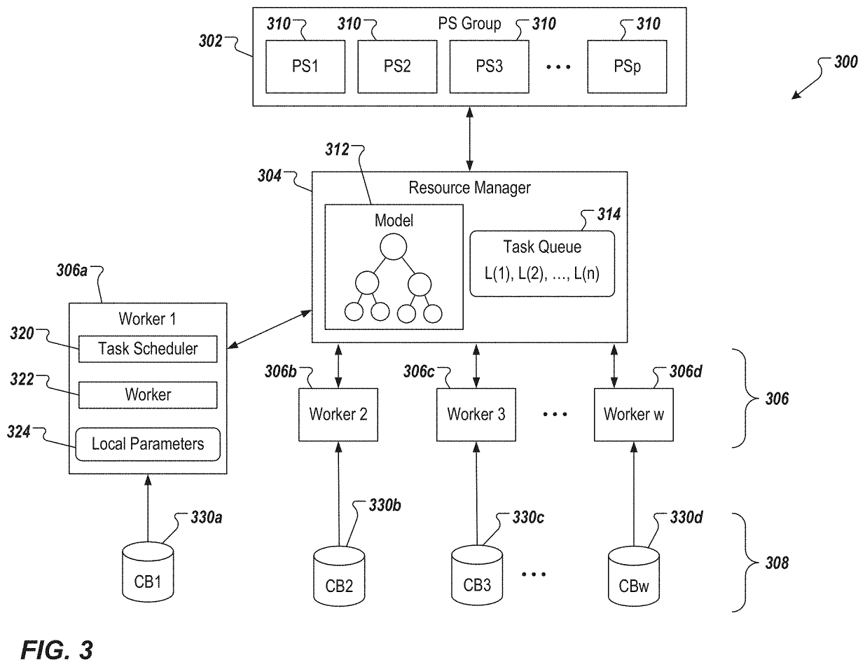

FIG. 3 depicts an example architecture 300 representing interactions between components during workflow execution in accordance with implementations of the present disclosure. The example of FIG. 3 includes a parameter server (PS) group 302, a resource manager 304, a set of workers 306 (including workers 306a, 306b, 306c, 306d), and a data set 308. The PS group 302 includes a set of PSs 310. The resource manager 304 processes a ML model 312 and a task queue 314. In some examples, each worker 306a, 306b, 306c, 306d includes a task scheduler 320, a worker module 322, and local parameters 324. The data set 308 includes column block (CB) data store 330a, 330b, 330c, 330d, each of which corresponds to a respective worker 306a, 306b, 306c, 306d.

In some examples, each worker 306a, 306b, 306c, 306d is provided at a respective location along with the corresponding CB data store 330a, 330b, 330c, 330d. That is, the workers 306a, 306b, 306c, 306d and the corresponding CB data store 330a, 330b, 330c, 330d are distributed across a cloud system (e.g., are at respective nodes of the cloud system). In some examples, each CB data store 330a, 330b, 330c, 330d represents only a portion of the features that are to be processed through the ML model 312. That is, the ML model 312 is to process sub-sets of features, and each CB data store 330a, 330b, 330c, 330d stores a respective sub-set of features. In some examples, the sub-sets of features are non-overlapping. In some examples, the resource manager 304 is provided at a centralized node of the cloud system. In some examples, the resource manager 304 is provided at a non-centralized node of the cloud system (e.g., is provided at a node of one of the workers 306a, 306b, 306c, 306d).

In accordance with implementations of the present disclosure, the example architecture 300 of FIG. 3 can be used to execute resource-efficient training of the ML model 312 and resource-efficient inference using the ML model 312. As described in further detail herein, the ML model 312 is provided as a decision tree model. More particularly, a decision tree model can be described as a set of decision rules, where each decision rule is a set of conditions that lead to another rule or a result.

For the training phase (i.e., providing and training a ML model), the resource manager 304, the workers 306a, 306b, 306c, 306d, and the PSs 310 work together to determine an optimal split and build the ML model 312. In some implementations, a stale synchronous parallel mechanism is used to train the ML model 312, which enables a reduction in training time. In some examples, the stale synchronous parallel mechanism enables the resource manager 304 to ignore local parameters from one or more of the workers 306a, 306b, 306c, 306d based on response times. Further, the generalization ability of the ML model 312 is improved.

In further detail, the resource manager 304 receives local parameters from each of the workers 306a, 306b, 306c, 306d and sends the local parameters to respective PSs 310. More particularly, the feature information each worker stores is different. For example, and without limitation, the worker 306a stores the temperature and outlook features, the 306b stores the humidity and windy features, and the worker 306c stores other features. Continuing with this example, the local parameters for the worker 306a can include (temperature: >=84, gains: 0.8; outlook: rain, gains: 0.7) and for the local parameters for the worker 306b could be (humidity: <82.5, gains:0.9; windy: yes, gains:0.3). The resource manager 304 communicates between the PS group 302 and the workers 306a, 306b, 306c, 306d to determine an optimal split of features at one or more split node. More particularly, a tree-based ML model, such as the ML model 312, can be divided (split) into sub-trees, each worker 306a, 306b, 306c, 306d managing a respective sub-tree. The nodes at which a decision tree is split can be referred to as split nodes. In some examples, the optimal split is determined using one or more algorithms, which can include, without limitation, Chi-square automatic interaction detection (CHAID), C4.5, and Classification and Regression Trees (CART). The overall ML model 312 is managed by the resource manager 304.

The resource manager 304 maintains the task queue 314. Each element in the task queue 314 is provided as a vector that includes identifiers (IDs) of data samples at a respective split node. For purposes of illustration, an example task queue 314 can include a vector [0, 1, 2, 3, 4, 5, 6, 7] representative of data samples for a parent node (e.g., root node). In some examples, the data samples include data that is to be processed during training. The parent node can be split into multiple sub-nodes (child nodes) and the vector correspondingly split. Continuing with the example above, the vector [0, 1, 2, 3, 4, 5, 6, 7] can be split within the task queue 314 to include a vector [0, 1, 3] and a vector [2, 4, 5, 6, 7]. In response to the vector being split, the vector is removed from the task queue 314. This example is representative of a split of the original parent node into to sub-nodes.

As noted above, each worker 306a, 306b, 306c, 306d only has a partial feature set. During training, each worker 306a, 306b, 306c, 306d pulls a task from the resource manager 304 and calculates the local parameters 324 (e.g., split features, split values, split gains). The local parameters 324 are sent back to the resource manager 304 and are combined to provide a set of global parameters. The resource manager 304 partitions the global parameters and provides a sub-set of global parameters to one or more of the PSs 310. That is, each PS 310 only receives a part of the global parameters that are partitioned by the resource manager 304. For example, if the set of PSs 302 includes p PSs 310, the global parameters will be divided into p parts (sub-sets), each part being sent to a respective PS 310. Each PS 310 determines a local optimal split (e.g., using CHAID, C4.5, CART) and updates the resource manager 304.

To start training, the task queue 314 in the resource manager 304 is initialized based on the data samples to be used for training (i.e., training data). As initialized, the task queue has a single element, which is a vector that includes the IDs of all of the data samples that are to be used for training. The resource manager 304 sends training tasks to the workers 306a, 306b, 306c, 306d. Each worker 306a, 306b, 306c, 306d calculates respective local parameters 324 for the data samples whose ID is contained in the task. The local parameters 324 are considered local, because the data are stored as the CB data store 330a, 330b, 330c, 330d of the workers 306a, 306b, 306c, 306d, respectively. Each worker 306a, 306b, 306c, 306d transmits its local parameters 324 to the resource manager 304.

The resource manager 304 receives the local parameters 324 from the workers 306a, 306b, 306c, 306d. In some examples, the resource manager 304 uses a control parameter (ACTIVE_RATIO, r_{ACT}) to determine the number of local parameters 324 that the resource manager receives 304. More particularly, the stale synchronous parallel mechanism is used to reduce the time cost for training and improve the generalization ability of the ML model 312. The control parameter (ACTIVE_RATIO, r_{ACT}) is used to determine which local parameters 324 will be accepted based on response times of the respective workers 306a, 306b, 306c, 306d, instead of waiting for synchronization of local parameters 324. In some examples, a response time is determined as a time from the resource manager 304 sending a task to the time that the resource manager 304 receives the local parameters from a respective worker 306a, 306b, 306c, 306d.

For example, in the example of FIG. 3, there are four CB data stores 330a, 330b, 330c, 330d and four workers 306a, 306b, 306c, 306d, respectively. In a non-limiting example, each CB data store 330a, 330b, 330c, 330d stores values for two features, making a total of 8 features. An example value of the control parameter (ACTIVE_RATIO, r_{ACT}) is 0.8. The resource manager 304 only accepts a threshold number (P_{L,THR}) of the local parameters 324, which is calculated based on the following example relationship:

P_{L,THR}=RND(f×r_{AcT})

where f is the total number of features across the CB data stores 330a, 330b, 330c, 330d. Using the example values provided above, P_{L,THR} is equal to 6 (e.g., P_{L,THR}=RND (8×0.8)). In this example, the resource manager 304 accepts the threshold number (P_{L,THR}) of the local parameters 324 and drops the remainder. In the example above, the resource manager 304 accepts local parameters for the first 6 features received of the 8 total features. By using the stale synchronous parallel mechanism, implementations of the present disclosure reduce the time waiting for the local parameters from some features. Due to the dropping of the local parameters of one or more features, randomness is also introduced into the best split selection process, described in further detail herein. This can prevent overfitting and improve the generality of the ML model 312.

Continuing, the resource manager 304 merges the (accepted) local parameters 324 into global parameters and partitions the global parameters into p parts. The resource manager 304 transmits the parts to the PSs 310, each PS 310 determining a local optimal split based on the received part. The local optimal splits from all parts are sent to a worker 306a, 306b, 306c, 306d through the resource manager 304. The worker 306a, 306b, 306c, 306d determines the best global split (e.g., using CHAID, CART, C4.5. Data representative of the best global split (e.g., split feature, split value) is transmitted to the resource manager 304, which updates the ML model 312.

In some examples, the resource manager 304 determines the particular worker(s) 306a, 306b, 306c, 306d that store(s) the split feature and sends a request to the worker 306a, 306b, 306c, 306d. The worker 306a, 306b, 306c, 306d returns a split result based on the task vector and the split value. In some examples, the resource manager 304 receives the best split (e.g., split feature: temperature, value:>=84). The best split represents a node that is to be added to the tree ML model. In some examples, a vector in the task queue is split based on the best split. For example, and with reference to the example above, the task queue can include a vector [0, 1, 2, 3, 4, 5, 6, 7] and the best split is determined to be (split feature: temperature, value:>=84). The resource manager 304 is stores data indicating which worker stores which feature data (e.g., the worker 306b stores the temperature feature information). Accordingly, the request can be sent to the appropriate worker. Based on the best split value (e.g., >=84), the task queue is split (e.g., [0, 1, 2, 3, 4, 5, 6, 7] is split into [0, 1, 3] and [2, 4, 5, 6, 7]). The resource manager 304 updates the task queue accordingly.

This training process is repeated the ML model 312 matches one or more specified criterion. For example, the training process can be executed until the ML model 32 achieves a maximum tree depth (e.g., maximum number of levels of nodes below a root node).

As described herein, implementations of the present disclosure enable multiple training tasks in the task queue 314 to be executed in parallel. As a result, the ML model 312 is built in parallel, thereby providing improved speed and reduced consumption of resources in the training phase, as compared to traditional techniques.

For the inference phase (i.e., providing predictions from a ML model), the distributed, tree-based data mining system of the present disclosure provides predictions using only part of the features that are stored at each worker 306. In some implementations, each worker 306a, 306b, 306c, 306d receives the ML model 312 from the resource manager 304. For each feature that the worker 306a, 306b, 306c, 306d has data values stored (in the respective CB data store 330a, 330b, 330c, 330d), each worker 306a, 306b, 306c, 306d generates respective binary code and provides the binary code to the resource manager 304. In response to receiving binary code from a worker 306a, 306b, 306c, 306d, the resource manager 304 sends the binary code, and any previously received binary code (e.g., received from another worker 306a, 306b, 306c, 306d), to a PS 310. In some examples, if there is no binary code previously received, the resource manager generates binary code including only l's with the same length as binary code that was received and sends both to the PS 310. In response to receiving the binary codes, the PS 310 performs an AND operation and returns the result to the resource manager 304.

This process is repeated until there is only a binary code with a 1 existing in the resource manager 304. This indicates that the prediction result (inference) by the ML model 312 is determined, and the resource manager 304 outputs the prediction result.

It can be noted that generation of the binary code can be done in parallel across the workers 306a, 306b, 306c, 306d. Further, the AND operation performed by the PS 310 is a relatively quick operation to perform and multiple PS s 310 in the PS group 302 can handle multiple binary codes in parallel. The parallel inference significantly reduces latency. Consequently, implementations of the present disclosure support use cases that require low latency, such as real-time sensor-based decision making (e.g., autonomous vehicles), and personalized push which is used in cloud computing systems.

To illustrate inference in accordance with implementations of the present disclosure, and as discussed above, a tree model can be described as a set of decision rules, where each decision rule is a set of conditions that are combined with an AND (&&) operation. Therefore, using which condition first to classify data would not affect the resulting prediction. The following represent an example, known decision tree model:

TABLE 1
Example Decision Tree Model

| Rule | Rule_Index | Rule_Content |
|---|---|---|
| 1 | 0 | (TEMP >= 84) => Do not Play |
| 2 | 1 | (TEMP < 84) && (OUTLOOK = Overcast) => Play |
| 3 | 2 | (TEMP < 84) && (OUTLOOK = Sunny)&& |
| | | (HUMIDITY < 82.5) => Play |
| 4 | 3 | (TEMP < 84) && (OUTLOOK = Sunny)&& |
| | | (HUMIDITY >= 82.5) => Do not Play |
| 5 | 4 | (TEMP < 84) && (OUTLOOK = Rainy)&& |
| | | (WINDY = Yes) => Do Not Play |
| 6 | 5 | (TEMP < 84) && (OUTLOOK = Rainy)&& |
| | | (WINDY = No) => Play |

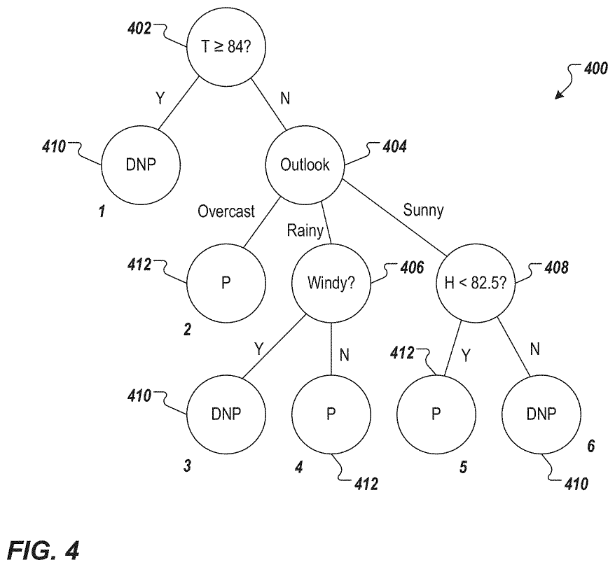

FIG. 4 depicts an example graphical representation 400 of the decision tree model of Table 1 to illustrate implementations of the present disclosure. The example decision tree model of Table 1 is a known decision tree model that is used herein for purposes of non-limiting illustration of implementations of the present disclosure. In the example of FIG. 4, the example graphical representation 400 depicts how the decision tree model can be used to determine whether a game (e.g., football) is to be played (play (P)) or is not to be played (do not play (DNP)) based on weather conditions.

In the example of FIG. 4, the example graphical representation 400 includes decision nodes 402, 404, 406, 408 and result nodes 410, 412. Each result node 410, 412 is a leaf node (i.e., a node having no child node(s)). The decision node 402 compares a temperate (T) to a threshold temperature (e.g., 84° F.). The decision node 404 determines whether the outlook is overcast, rainy, or sunny. The decision node 406 determines whether it is windy (e.g., a whether a windspeed exceeds a threshold wind speed). The decision node 408 compares a humidity (H) to a threshold humidity (e.g., 82.5%). The result node 410 represents a decision no to play (DNP) and the result node 412 represents a decision to play (P).

With reference to Table 1 and FIG. 4, for every rule, it can be seen that the prediction result would be unchanged regardless of the order of the conditions. In view of this, the distributed, tree-based data mining system of the present disclosure provides a prediction system that can be applied in scenarios where data is arranged in the column block format. In accordance with implementations of the present disclosure, each worker 306 generates binary code based on feature information that the respective worker 306 has access to. A final prediction result is obtained by gathering the binary code from all workers 306.

In further detail, a multi-digit binary code can be used to represent each leaf node (i.e., result node). An index is determined for each leaf node, where a 1 is provided in the multi-digit binary code depending on the location of the respective leaf node. With reference to the example decision tree model of Table 1 and FIG. 4, a six-digit binary code can be used to represent a respective result node 410, 412, where a 1 represents a corresponding result node. The index for a result node 410, 412 corresponds to the position in the binary code to provide the following indices:

TABLE 2
Example Binary Code

| Rule | Binary Code |
|---|---|
| 1 | 100000 |
| 2 | 010000 |
| 3 | 001000 |
| 4 | 000100 |
| 5 | 000010 |
| 6 | 000001 |

Using the example decision tree model of Table 1 and FIG. 4 and the example architecture 300 of FIG. 3 as non-limiting examples, an example execution of inference in accordance with implementations of the present disclosure will be described. In this example, the information about the feature OUTLOOK and the feature TEMP are stored at the worker 306a as a portion of the CB data store 330a and the feature HUMIDITY and the feature WINDY are stored at the worker 306b as a portion of the CB data store 330b. An example distributed data set can be provided as follows:

TABLE 3
Example Distributed Data Set

| Feature | Value | Location |
|---|---|---|
| OUTLOOK | Sunny | 306a/330a |
| TEMP | 75 | 306a/330a |
| HUMIDITY | 70 | 306b/330b |
| WINDY | Y | 306b/330b |

For the worker 306a, the prediction is based on the feature OUTLOOK and the feature TEMP. Because, using the example distributed data set, OUTLOOK is Sunny and TEMP is 75, it is impossible to reach the leaf nodes 410, 412 indexed by 1, 2, 3, 4. In the binary code that is generated by the workers 306a, 306b, a 0 is assigned to the unreachable leaf nodes 410, 412, and a 1 is assigned to the reachable leaf nodes 410, 412. As a result, and in this example, the worker 306a generates a binary code of 000011 for the data it has access to, and the worker 306b generates a binary code of 111010 for the data it has access to. In some examples, the binary code of each of the worker 306a and the worker 306b is provided to the resource manager 304, which performs an AND operation on the binary code. In this example, the final result is 000010, which indicates that the leaf node indexed by 5 is the prediction result (Play). Because all of the conditions in a rule are composed by the AND operation, implementations of the present disclosure can guarantee that, in the final binary code, there is only a single 1 remaining and the prediction is correct. This is because, for each data, the AND operation is performed on the binary code provided from all workers.

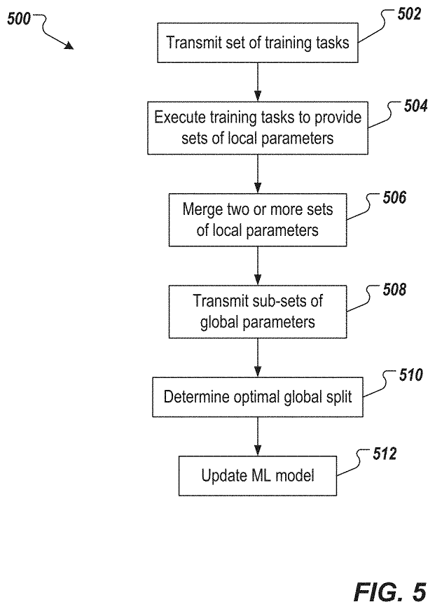

FIG. 5 depicts an example process 500 that can be executed in accordance with implementations of the present disclosure. In some examples, the example process 500 is provided using one or more computer-executable programs executed by one or more computing devices. In some examples, the example process 500 is executed to train a ML model.

A set of training tasks is transmitted (502). For example, and as described in detail herein, a resource manager node (e.g., the resource manager 304 of FIG. 3) transmits a set of training tasks to a set of worker nodes (e.g., the worker nodes 306a, 306b, 306c, 306d). The set of workers nodes includes two or more worker nodes distributed across the cloud system. Each worker node has access to a respective local data store (e.g., the CB data stores 330a, 330b, 330c, 330d of FIG. 3). In some examples, the training tasks include a set of identifiers, each identifier indicating data that is to be used to execute the training task. Training tasks are executed to provide sets of local parameters (504). For example, and as described in detail herein, each worker node in the set of worker nodes executes a respective training task to provide a set of local parameters and transmits the set of local parameters to the resource manager node. In some examples, each worker node executes the training task based on data indicated in the training task that the worker node has access to in its local data stored.

Two or more sets of local parameters are merged (506). For example, and as described in detail herein, the resource manager node receives sets of local parameters from worker nodes and merges two or more sets of local parameters. In some examples, and as described herein, the two or more sets of local parameters is determined based on a control parameter that limits the two or more sets of local parameters to less than all sets of local parameters received from the set of worker nodes. Sub-sets of global parameters are transmitted (508). For example, and as described in detail herein, the resource manager node partitions the set of global parameters into sub-sets of global parameters and transmits each sub-set of global parameters to a parameters server (e.g., the PSs 310 of FIG. 3) in a group of parameters servers (e.g., the PS group 302 of FIG. 3).

An optimal global split is determined (510). For example, and as described in detail herein, a set of local optimal splits is received by the resource manager node, each local optimal split in the set of local optimal splits being transmitted to the resource manager node from a respective parameter server. The optimal global split is determined by a worker node based on the set of local optimal splits, the optimal global split representing a feature of the ML model. The ML model is updated (512). For example, and as described in detail herein, the resource manager node updates the ML model based on the best split parameters. It is determined whether training is complete. If the training is complete, the ML model is made available for inference. If the training is not complete, the example process 500 loops back to perform another iteration.

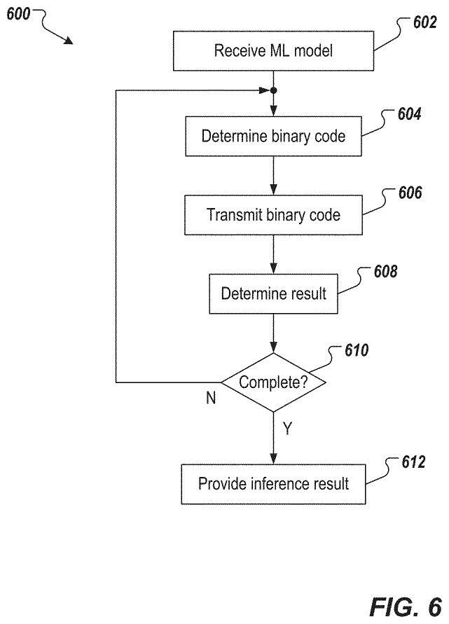

FIG. 6 depicts an example process 600 that can be executed in accordance with implementations of the present disclosure. In some examples, the example process 600 is provided using one or more computer-executable programs executed by one or more computing devices. In some examples, the example process 600 is executed for inference using a ML model.

A ML model is received (602). For example, and as described in detail herein, each worker node in the set of worker nodes receives the ML model from the resource manager node. Binary code is determined (604). For example, and as described in detail herein, each worker node determines a binary code. In some examples, the binary code represents a portion of the ML model that the worker node is capable of resolving using at least a portion of the data stored in the local data store accessible by the worker node. For example, a multi-digit binary code can be used to represent each leaf node (i.e., result node) and whether a respective worker is able to reach respective leaf nodes based on the at least a portion of the data stored in the local data store accessible by the worker node. Using the example above, a binary code of 000011 indicates that a respective worker node (i.e., the worker node that generated the binary code) is able to reach leaf nodes 5 and 6 of an ML model using the data it has access to, but is not able to reach leaf nodes 1, 2, 3, or 4.

Binary code is transmitted (606) and a result is determined (608). For example, and as described in detail herein, the resource manager node transmits a set of binary codes to a parameter server, the parameter server executing an operation on the set of binary codes to provide a result to the resource manager node. For example, the parameter server executes an AND operation to provide the result. It is determined whether inference is complete (610). For example, and as described in detail herein, it is determined whether the result determined from the binary codes received from the worker nodes includes a single value (e.g., 1) and, if so, inference is determined to be complete. For example, if the result calculated by the AND operation returns a binary code of 111111, inference is complete. If inference is not complete, the example process 600 loops back. If inference is complete, an inference result is provided (612). For example, and as described in detail herein, the resource manager node provides an inference result of the ML model.

As described herein, implementations of the present disclosure provide one or more of the following example advantages. Implementations of the present disclosure provide for distributed tree-based data mining being executed across distributed worker nodes closest to respective data storage devices. In this manner, data transfer and bandwidth consumption of the network are reduced, and unauthorized access to sensitive data is minimized. For example, while local parameters and binary code are transmitted from the worker nodes to the resource manager, the underlying data remains in storage at the locations of the respective worker nodes. As another example, data gathered at distributed work nodes from devices of similar types and similar features can be stored together. In this manner, implementations of the present disclosure enable more efficient processing of tree-based algorithms to perform data preprocessing and partition computation across the set of features, which is a more natural way of feature splitting for tree-based models. As another example, in addition to data parallelism, implementations of the present disclosure support model parallelism. For example, several central parameter servers are used to summarize parameters and push updated parameters back to the distributed work nodes. Each parameter server only communicates with a range of worker nodes, such that efficiencies in communication are achieved. As still another example, implementations of the present disclosure ensure high-throughput execution of building tree-based ML models through the stale synchronous parallel mechanism, instead of waiting for synchronization every time the tree-based ML model grows. This also improves the generalization ability of the tree-based ML models, as described herein. As yet another example, implementations of the present disclosure provide for parallel prediction (inference) at the feature level, which dramatically reduces inference latency that would otherwise occur. In this manner, ML model inference for real-time decision making is enabled.

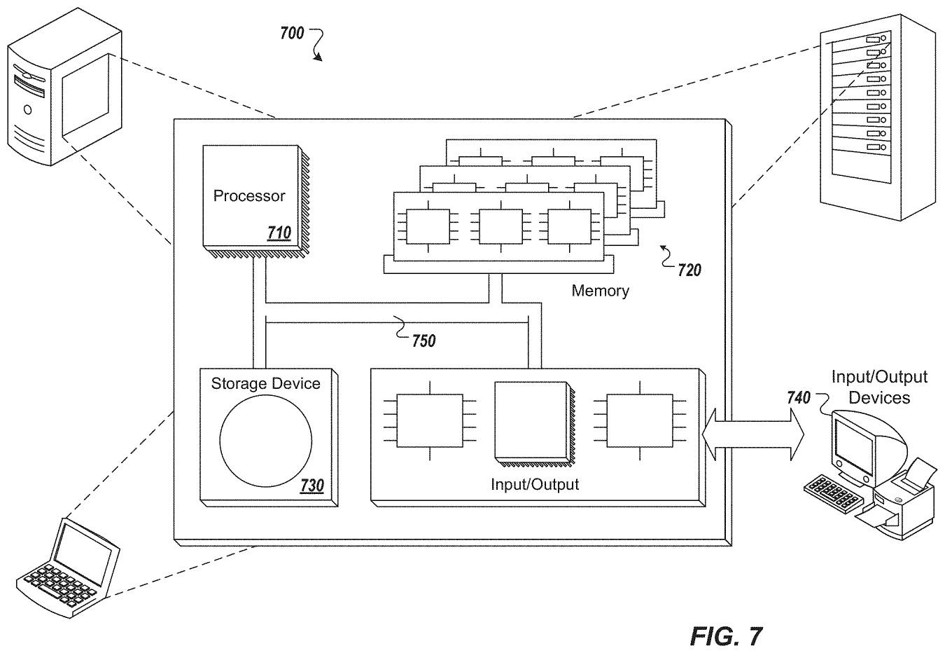

Referring now to FIG. 7, a schematic diagram of an example computing system 700 is provided. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, 740 are interconnected using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. In some implementations, the memory 720 is a volatile memory unit. In some implementations, the memory 720 is a non-volatile memory unit. The storage device 730 is capable of providing mass storage for the system 700. In some implementations, the storage device 730 is a computer-readable medium. In some implementations, the storage device 730 may be a floppy disk device, a hard disk device, an optical disk device, or a tape device. The input/output device 740 provides input/output operations for the system 700. In some implementations, the input/output device 740 includes a keyboard and/or pointing device. In some implementations, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASIC s (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for training of machine learning (ML) models and executing inference using the ML models in cloud systems, the method being executed by one or more processors and comprising:
transmitting, from a resource manager node, a set of training tasks to a set of worker nodes, the set of workers nodes comprising two or more worker nodes distributed across the cloud system and each having access to a respective local data store, the set of training tasks being executed to provide a ML model;
by each worker node in the set of worker nodes:
executing a respective training task to provide a set of local parameters, and
transmitting the set of local parameters to the resource manager node;
merging, by the resource manager node, two or more sets of local parameters to provide a set of global parameters;
transmitting, by the resource manager node, a sub-set of global parameters to each parameter server in a set of parameter servers;
receiving, by the resource manager node, a set of local optimal splits, each local optimal split in the set of local optimal splits being transmitted to the resource manager node from a respective parameter server;
determining an optimal global split based on the set of local optimal splits, the optimal global split representing a feature of the ML model; and
updating, by the resource manager node, the ML model based on the optimal global split.

2. The method of claim 1, wherein each training task comprises a set of identifiers, each identifier indicating data that is to be used to execute the training task.

3. The method of claim 1, wherein the two or more sets of local parameters is determined based on a control parameter that limits the two or more sets of local parameters to less than all sets of local parameters received from the set of worker nodes.

4. The method of claim 1, further comprising, during inference:
receiving, by a worker node, the ML model from the resource manager node;
determining, by the worker node, a binary code based on the ML model and data stored in a local data store accessible by the worker node;
transmitting, by the worker node, the binary code to the resource manager node;
providing, by the resource manager node, a set of binary codes to a parameter server, the set of binary codes comprising the binary code, the parameter server executing an operation on the set of binary codes to provide a result to the resource manager; and
determining, by the resource manager, an inference result of the ML model at least partially based on the result.

5. The method of claim 4, wherein the binary code represents a portion of the ML model that the worker node is capable of resolving using at least a portion of the data stored in the local data store accessible by the worker node.

6. The method of claim 1, wherein each local data store comprises a column-oriented data store.

7. The method of claim 1, wherein the ML model comprises a decision tree.

8. A non-transitory computer-readable storage medium coupled to one or more processors and having instructions stored thereon which, when executed by the one or more processors, cause the one or more processors to perform operations for training of machine learning (ML) models and executing inference using the ML models in cloud systems, the operations comprising:
transmitting, from a resource manager node, a set of training tasks to a set of worker nodes, the set of workers nodes comprising two or more worker nodes distributed across the cloud system and each having access to a respective local data store, the set of training tasks being executed to provide a ML model;
by each worker node in the set of worker nodes:
executing a respective training task to provide a set of local parameters, and
transmitting the set of local parameters to the resource manager node;
merging, by the resource manager node, two or more sets of local parameters to provide a set of global parameters;
transmitting, by the resource manager node, a sub-set of global parameters to each parameter server in a set of parameter servers;
receiving, by the resource manager node, a set of local optimal splits, each local optimal split in the set of local optimal splits being transmitted to the resource manager node from a respective parameter server;
determining an optimal global split based on the set of local optimal splits, the optimal global split representing a feature of the ML model; and
updating, by the resource manager node, the ML model based on the optimal global split.

9. The non-transitory computer-readable storage medium of claim 8, wherein each training task comprises a set of identifiers, each identifier indicating data that is to be used to execute the training task.

10. The non-transitory computer-readable storage medium of claim 8, wherein the two or more sets of local parameters is determined based on a control parameter that limits the two or more sets of local parameters to less than all sets of local parameters received from the set of worker nodes.

11. The non-transitory computer-readable storage medium of claim 8, wherein operations further comprise, during inference:
receiving, by a worker node, the ML model from the resource manager node;
determining, by the worker node, a binary code based on the ML model and data stored in a local data store accessible by the worker node;
transmitting, by the worker node, the binary code to the resource manager node;
providing, by the resource manager node, a set of binary codes to a parameter server, the set of binary codes comprising the binary code, the parameter server executing an operation on the set of binary codes to provide a result to the resource manager; and
determining, by the resource manager, an inference result of the ML model at least partially based on the result.

12. The non-transitory computer-readable storage medium of claim 11, wherein the binary code represents a portion of the ML model that the worker node is capable of resolving using at least a portion of the data stored in the local data store accessible by the worker node.

13. The non-transitory computer-readable storage medium of claim 8, wherein each local data store comprises a column-oriented data store.

14. The non-transitory computer-readable storage medium of claim 8, wherein the ML model comprises a decision tree.

15. A system, comprising:
a computing device; and
a computer-readable storage device coupled to the computing device and having instructions stored thereon which, when executed by the computing device, cause the computing device to perform operations for training of machine learning (ML) models and executing inference using the ML models in cloud systems, the operations comprising:
transmitting, from a resource manager node, a set of training tasks to a set of worker nodes, the set of workers nodes comprising two or more worker nodes distributed across the cloud system and each having access to a respective local data store, the set of training tasks being executed to provide a ML model;
by each worker node in the set of worker nodes:
executing a respective training task to provide a set of local parameters, and
transmitting the set of local parameters to the resource manager node;
merging, by the resource manager node, two or more sets of local parameters to provide a set of global parameters;
transmitting, by the resource manager node, a sub-set of global parameters to each parameter server in a set of parameter servers;
receiving, by the resource manager node, a set of local optimal splits, each local optimal split in the set of local optimal splits being transmitted to the resource manager node from a respective parameter server;
determining an optimal global split based on the set of local optimal splits, the optimal global split representing a feature of the ML model; and
updating, by the resource manager node, the ML model based on the optimal global split.

16. The system of claim 15, wherein each training task comprises a set of identifiers, each identifier indicating data that is to be used to execute the training task.

17. The system of claim 15, wherein the two or more sets of local parameters is determined based on a control parameter that limits the two or more sets of local parameters to less than all sets of local parameters received from the set of worker nodes.

18. The system of claim 15, wherein operations further comprise, during inference:
receiving, by a worker node, the ML model from the resource manager node;
determining, by the worker node, a binary code based on the ML model and data stored in a local data store accessible by the worker node;
transmitting, by the worker node, the binary code to the resource manager node;
providing, by the resource manager node, a set of binary codes to a parameter server, the set of binary codes comprising the binary code, the parameter server executing an operation on the set of binary codes to provide a result to the resource manager; and
determining, by the resource manager, an inference result of the ML model at least partially based on the result.

19. The system of claim 18, wherein the binary code represents a portion of the ML model that the worker node is capable of resolving using at least a portion of the data stored in the local data store accessible by the worker node.

20. The system of claim 15, wherein each local data store comprises a column-oriented data store.
